(19) United States
(12) Patent Application Publication
(10) Pub. No.: US 2021/0107369 A1
(43) Pub. Date: Apr. 15, 2021

(54) CHARGING HUB FOR URBAN MICRO-MOBILITY BEHICLES

(71) Applicant: Get Charged, Inc. dba Charge, New York, NY (US)

(72) Inventors: Mark Lojek, Livingston Manor, NY (US); Dan Waldman, Englewood Cliffs, NY (US); Andrew Fox, New York, NY (US)

(21) Appl. No.: 17/071,071

(22) Filed: Oct. 15, 2020

Related U.S. Application Data
(60) Provisional application No. 62/915,103, filed on Oct. 15, 2019.

(51) Int. Cl. B60L 53/31; B60L 53/30; H02J 7/00; B65D 88/12; B65D 90/22

(52) U.S. Cl. CPC B60L 53/31; B60L 53/305; H02J 7/0029; B65D 2585/686; B65D 90/22; B60L 2200/24; B65D 2588/74; B65D 88/121

(57) ABSTRACT

A charging hub for charging micro-mobility vehicles (e-vehicles) including a rectangular box-like shipping container with at least one door. A power source leading to the container. One or more rectangular box-like bays inside the shipping container. Each bay includes at least one door and a surface. A plurality of smart charging stations are included to charge e-vehicles inside each bay and connected to the power source. A vertically tiered charging platform is included inside each bay. Each tier includes at least one of the smart charging stations.

### TECHNICAL FIELD

The subject matter of this invention relates to a charging hub for urban micro-mobility vehicles, including electric scooters, electric bikes, etc.

### BACKGROUND

Micro-mobility rechargeable vehicles, e.g., scooters, bikes, etc., (“e-vehicles”) have become extremely popular in urban settings. Current providers such as BIRD, LIME, etc., rely on independent contractors (referred to herein as “chargers”) to recharge scooters, often in their own home at night. Chargers, for example, pick up scooters at designated locations, bring them to their home for charging overnight, and return them to designated locations in the morning. Chargers receive a monetary reward for their efforts. Each provider generally utilizes a proprietary dispatch service and downloadable smartphone applications which track and broadcast provider-based vehicle information.

Unfortunately, charging is subject to significant chaos and the current approach is both unstainable and unsafe.

### SUMMARY

Aspects of the disclosure describe a charging hub for charging micro-mobility vehicles (e-vehicles), comprising: a rectangular box-like shipping container with at least one door; a power source leading to the container; one or more rectangular box-like bays inside the shipping container, wherein each bay has at least one door and a floor; a plurality of smart charging stations configured to charge e-vehicles inside each bay and connected to the power source; and a vertically tiered charging platform inside each bay, wherein each tier includes at least one of the smart charging stations.

A second aspect discloses vertically tiered charging platform, comprising: a plurality of decks above a surface, wherein a front deck rests on the surface, wherein a middle deck rests on the front deck, and wherein a middle deck leading edge is set back from a front deck leading edge; wherein a back deck rests on the middle deck, and wherein a back leading edge is set back from a middle deck leading edge; at least one notch in each deck; and at least one charging cable.

A third aspect discloses vertically tiered charging platform, comprising: a plurality of decks above a surface, wherein each deck rests on the surface, and at least one smart charging station.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a front view of a charging hub for micro-mobility rechargeable vehicles including four charging bays according to embodiments.

FIG. 2 depicts a perspective view of front and side views of the charging hub according to embodiments.

FIG. 3 depicts a perspective view of back and side views of the charging hub according to embodiments.

FIG. 3 shows a side cross-section view of one charging bay with vertically tiered charging platforms according to embodiments.

FIG. 4 depicts a top-down cross-section view of charging hub including one or more bays inside the container according to embodiments.

FIG. 5 depicts an interior perspective of charging hub including one or more bays inside the shipping container according to embodiments.

FIGS. 6-8 depict side cross-section views of one charging bay according to embodiments.

FIGS. 9 and 10 depict perspective side views of one charging bay according to embodiments.

FIGS. 11 and 12 depict perspective front views of one embodiment of one charging bay with the vertically tiered charging platform including four decks according to embodiments.

FIG. 13 depicts a front view of one embodiment of one charging bay with the vertically tiered charging platform including charging electrical system according to embodiments.

FIG. 14 depicts a perspective view of front and side views of the charging hub according to embodiments.

The drawings are not necessarily to scale. The drawings are merely schematic representations and are not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

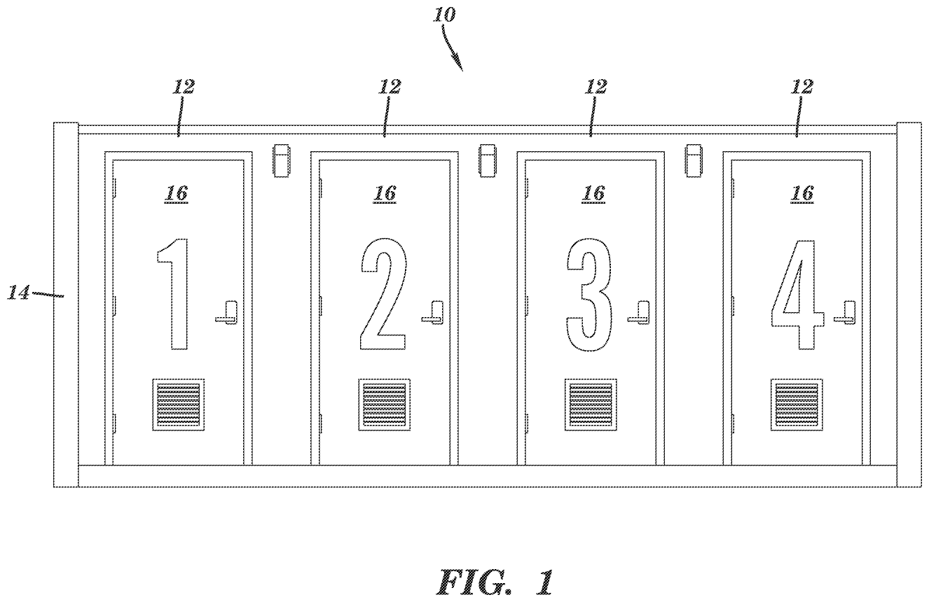

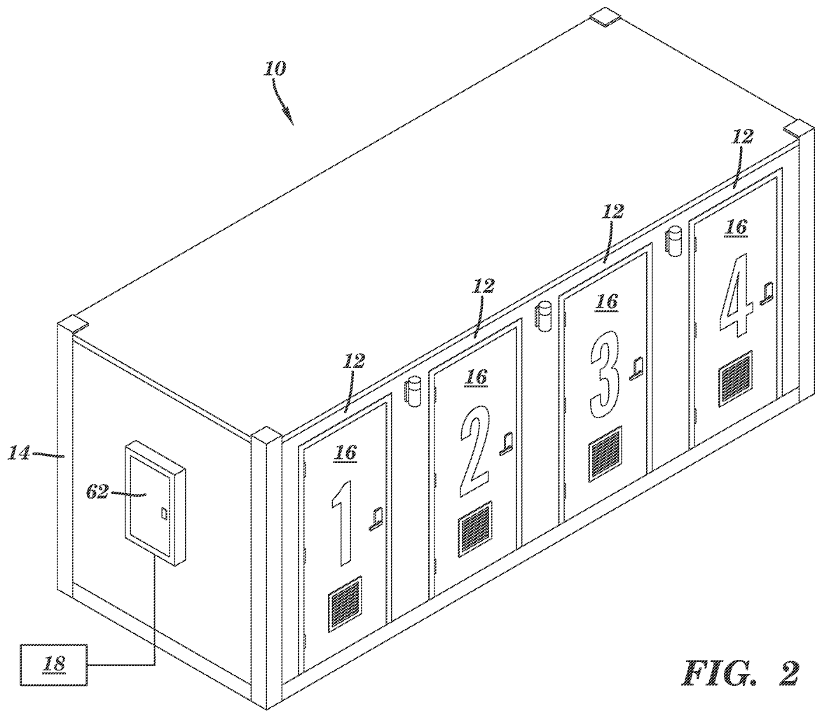

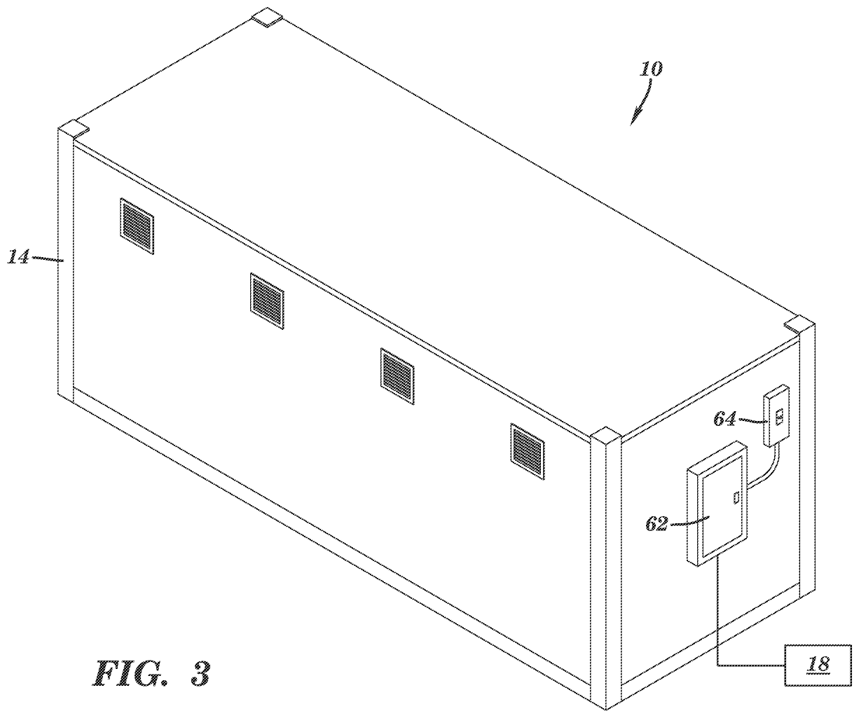

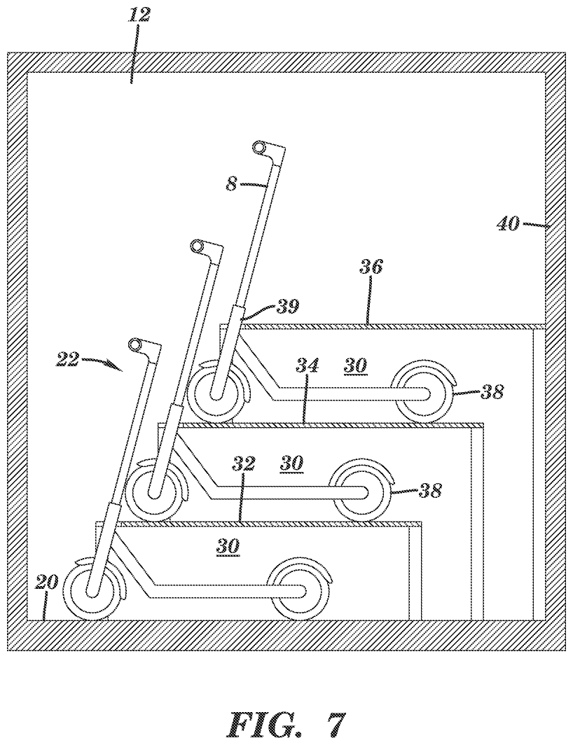

Referring now to the drawings, FIGS. 1-3 depict exterior views of an illustrative charging hub 10 for micro-mobility rechargeable vehicles 8 (FIG. 7), and FIG. 1 depicts a front view of the charging hub 10 including four charging bays 12. FIG. 2 depicts a perspective view of the front and side walls of the charging hub 10. FIG. 3 depicts a perspective view of back and side walls of the charging hub 10. In the depicted illustrative embodiment, charging hub 10 includes a rectangular box-like metal shipping container 14. Charging hub 10 could however be implemented using any structure such as a prefabricated or existing building, fencing, etc., and could be constructed using any known construction methods and materials.

Charging hub 10 includes at least one door 16 to enter and exit an associated bay within the charging hub 10. Door 16 may be any variety providing it allows for a person with a micro-mobility rechargeable vehicle 8 the ability to enter and exit the charging hub 10. In the illustrative example, charging hub includes four doors 16 providing access to four bays, however it is understood that charging hub 10 could be implemented with more or fewer doors/bays.

Charging hub 10 includes at least one power source 18 leading to the charging hub 10. Power source 18 may be any source of power including local utility grid, solar, gas generators, wind, AC, DC, etc., and other known methods of power generation and supply. Solar may be provided by solar panels affixed to or separate from the container 14. Solar panels affixed to the container 14 may be affixed on any surface suitable for exposing them to the sun.

Container 14 may be any size. Embodiments may include container 14 sized to fit into various spaces including, for example, a parking space, a garage, a vacant lot. Container 14 may include a standardized shipping container. Garage/parking lot/vacant lot owners, e.g., can be compensated by a service to locate the container 14 thereon. Exposed surfaces of the container 14 may be used for advertising space.

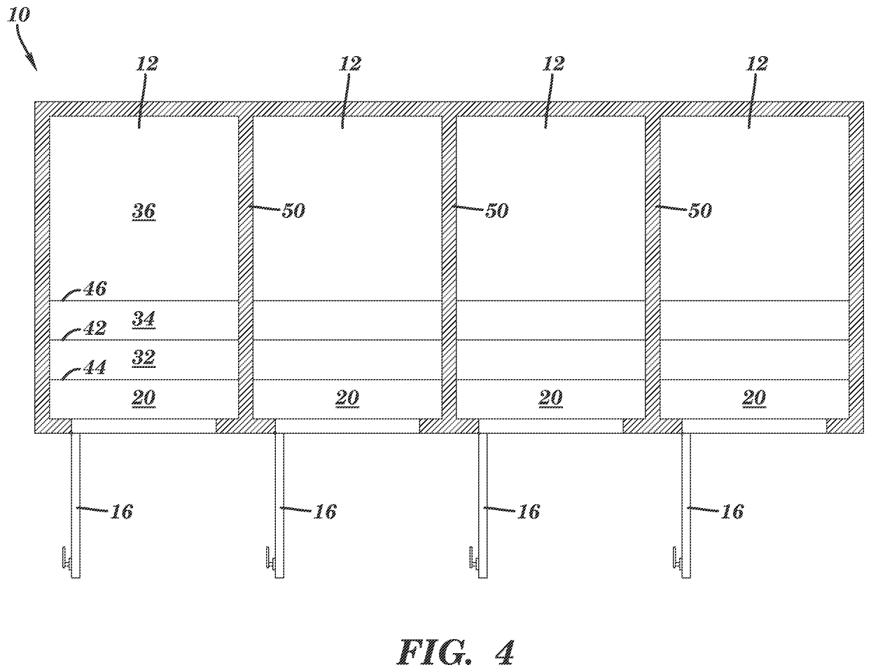

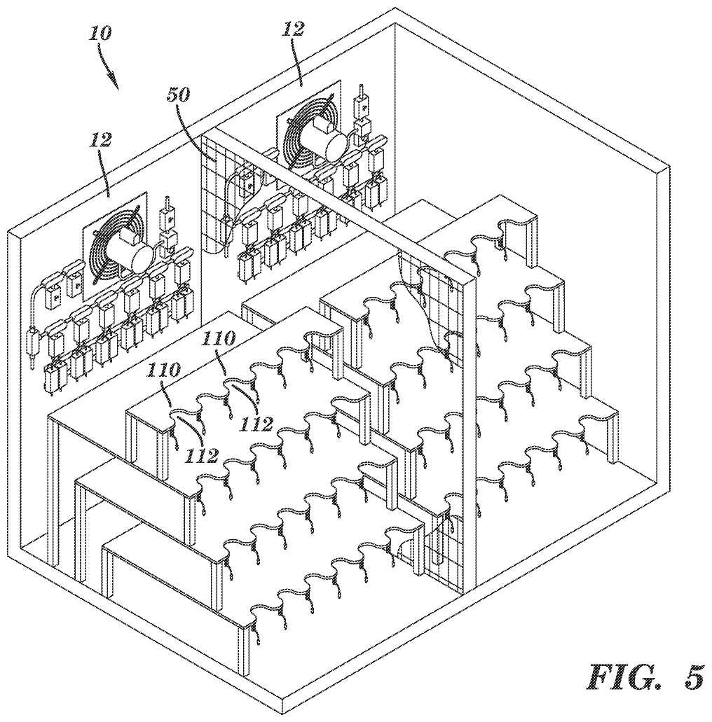

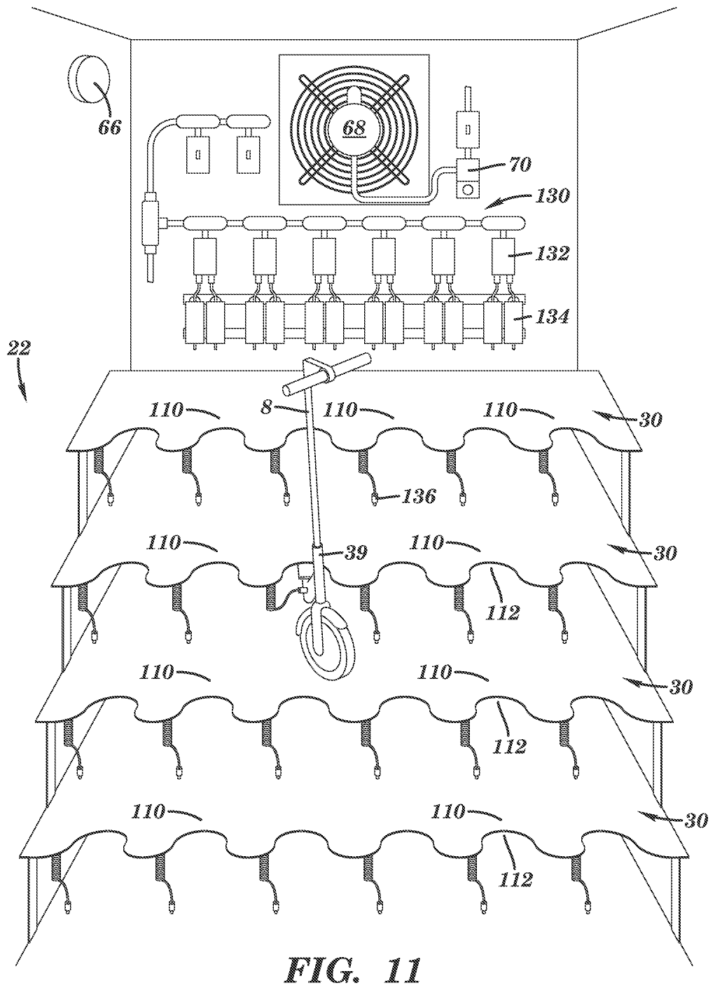

FIG. 4 depicts a top-down cross-section view of charging hub 10 including four bays 12 inside the container 14, wherein each bay 12 has at least one bay door 16 and a floor 20. Each bay 12 may include a plurality of smart charging stations 110 (FIG. 11) connected to the power source 18 and configured to charge the micro-mobility rechargeable vehicles 8 stored inside each bay 12. As shown in FIGS. 5 and 11, each smart charging station 110 may include at least one notch 112 for positioning and storing a vehicle and at least one charging cable 136 that can connect and charge a vehicle. The notch may be configured to accommodate a neck 39 of a micro-mobility vehicle

FIG. 5 depicts an interior perspective of charging hub 10 including one or more bays 12 inside the container 14. Adjacent bays 12 may be separated by a bay wall 50. Each bay wall 50 may be constructed of any suitable material including, for example, metal, wood, plastic, plexiglass, or composite material. Each bay wall 50 may be a non-permeable, for example, a solid or permeable, for example, a grate. Each bay wall 50 may be suitable to act as a support structure for container. Each bay wall 50 may be suitable to prevent or deter access between bays 12.

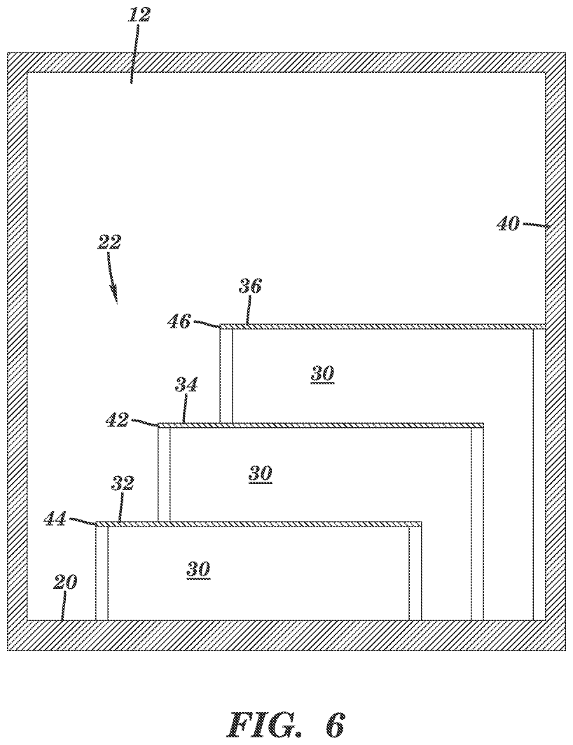

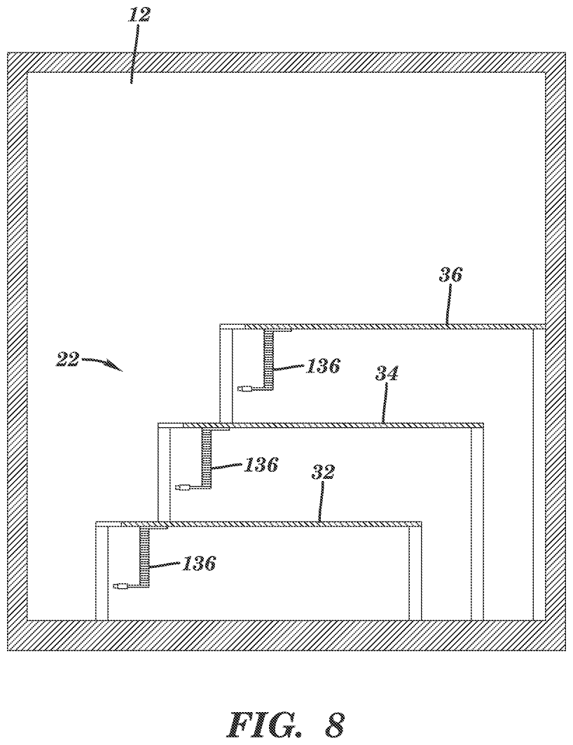

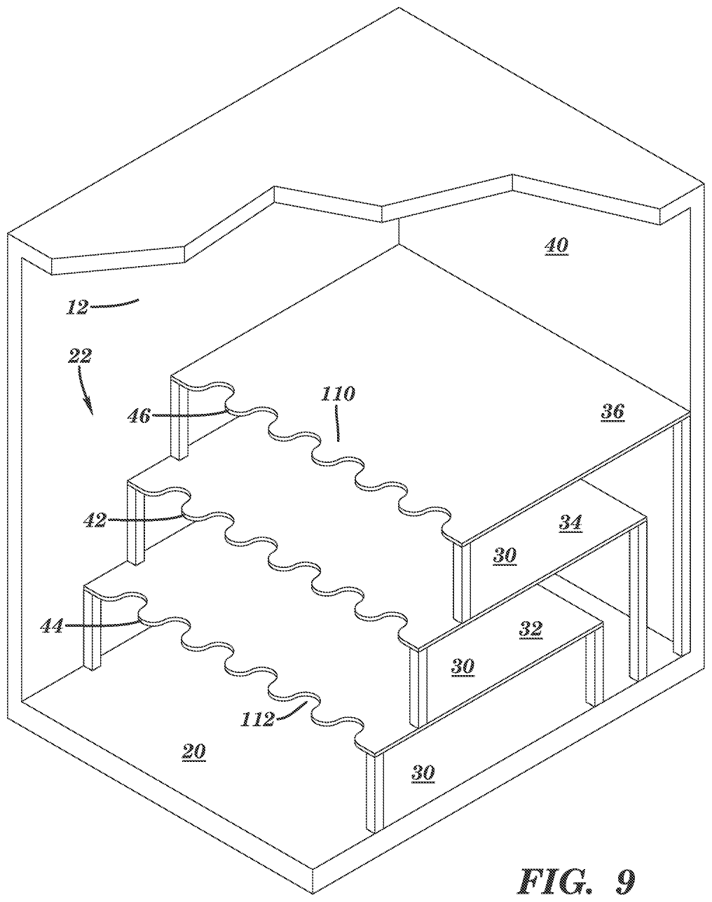

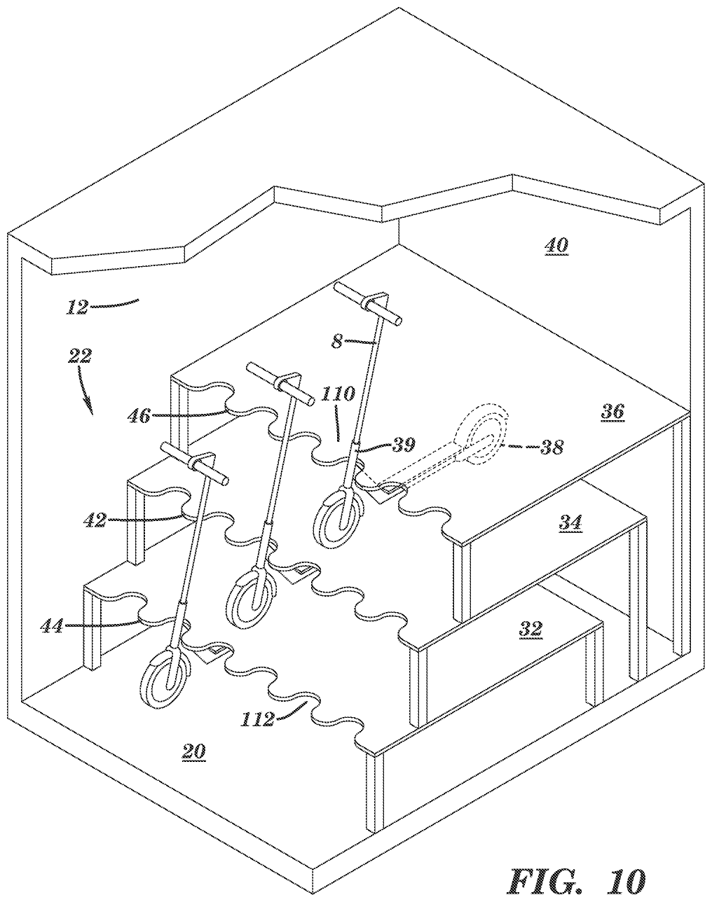

FIGS. 6-8 depict side cross-section views of one charging bay 12. FIGS. 9 and 10 depict perspective side views of one charging bay 12. Each bay 12 may include a vertically tiered charging platform 22 inside each bay, wherein each tier 30 of the vertically tiered charging platform 22 includes at least one of the smart charging stations 110.

Vertically tiered charging platform 22 may include a front deck 32, a middle deck 34, and a back deck 36. Front deck 32 may be closest to the floor 20, middle deck 34 is above the front deck 32, and the back deck 36 is above the middle deck 34. A middle deck leading edge 42 may be set back from a first deck leading edge 44. A back deck leading edge may be set back from a middle deck leading edge 42. Each of the front deck 32, the middle deck 34, and the back deck 36 may be spaced to accommodate a rear portion 38 of micro-mobility rechargeable vehicles 8 at each of the smart charging stations 110. Each of the front deck 32, the middle deck 34, and the back deck 36 may be adapted to accommodate insertion and removal of micro-mobility rechargeable vehicles 8 at each of the smart charging stations 110 (i.e., allowing for easy slide in and out of the vehicle). For example, FIGS. 7 and 10 depict vehicles (i.e., scooters 8) backed into and stored on each of the three decks. Although shown with three decks, other embodiments of vertically tiered charging platform 22 may include more or less decks.

Any of vertically tiered charging platform 22, front deck 32, the middle deck 34, and the back deck 36 may be constructed of any suitable material including, for example, metal, plastic, or wood. Any of vertically tiered charging platform 22, front deck 32, the middle deck 34, and the back deck 36 may be affixed to each bay 12 at floor 20 or container wall 40. Alternatively, any of vertically tiered charging platform 22, front deck 32, the middle deck 34, and the back deck 36 may be freely removable from any bay 12.

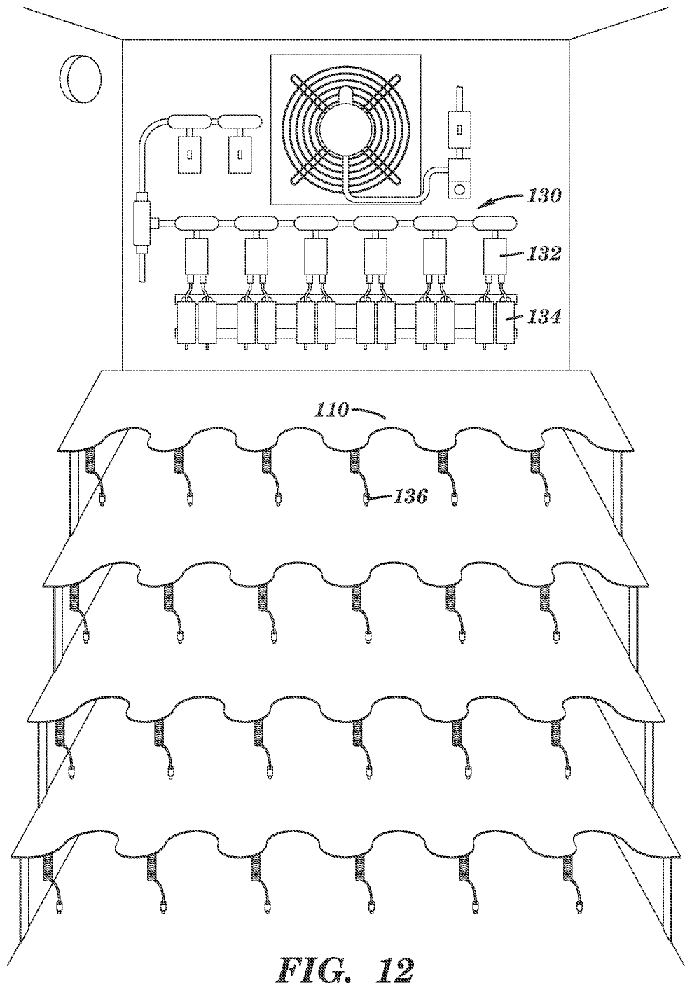

FIGS. 11 and 12 depict perspective front views of one embodiment of one charging bay 12 with the vertically tiered charging platform 22 including four tiers 30. While three and four tiers 30 have been depicted, vertically tiered charging platform 22 may include any number of tiers 30. Each tier 30 includes one deck 32, 34, 36 and each deck 32, 34, 36 may include any number of smart charging stations 110.

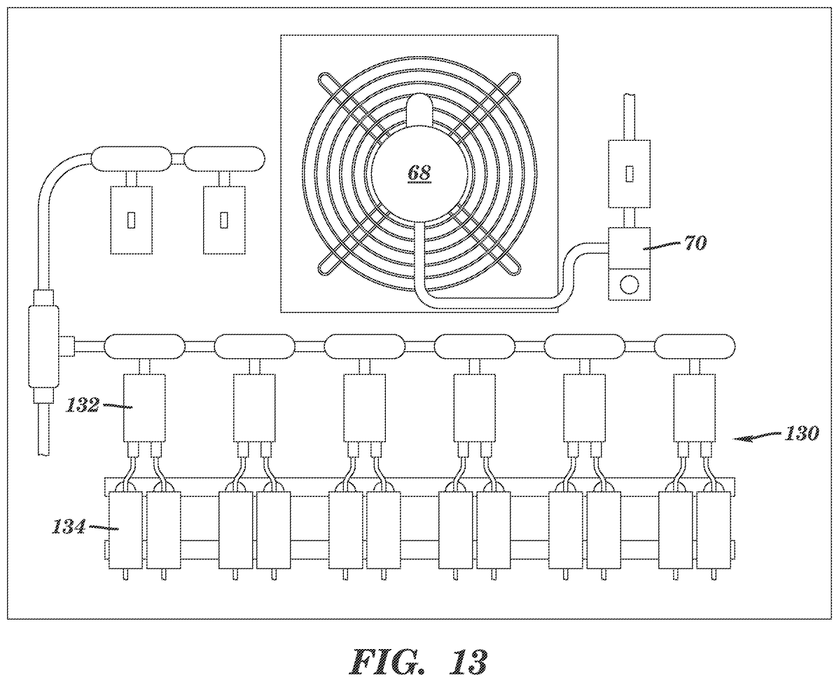

FIG. 13 depicts a front view of one embodiment of one charging bay 12 with the vertically tiered charging platform 22 including charging electrical system 130. Charging electrical system 130 may include a junction box 132 and at least one current conversion module 134, for example, a constant current light emitting diode (LED) driver. Each current conversion module 134 may receive a first electrical current from the junction box 132 and discharge a second electrical current to at least one charging cable 136. Each charging cable 136 may be attached to one of the batteries of one of the micro-mobility rechargeable vehicles 8. First electrical current may be AC or DC and may be any voltage, for example, including 120 volt or 220 volt. Second electrical current may be converted to accommodate each battery, for example, 38 volt, DC at 2 amps is common charging current for lithium ion batteries for micro-mobility rechargeable vehicles 8.

Referring to FIGS. 1-3, 11, and 13, charging hub 10 may include an outdoor mounted electrical panel 62. Charging hub 10 may include a fireman safety disconnect panel 64. Charging hub 10 and each bay 12 may include a fire and smoke detector 66. Charging hub 10 and each bay 12 may include a fire suppression system. Fire suppression system may include heat detection, smoke detection, and fire suppression including water, chemical, and other known forms of fire suppression. Charging hub 10 and each bay 12 may include at least one exhaust system 68. Charging hub 10 and each bay 12 may include at least one environmental control system 70. Environmental control system 70 may include thermostats, humidity controls, heaters, air conditioning, humidifiers, and other environmental detection and control.

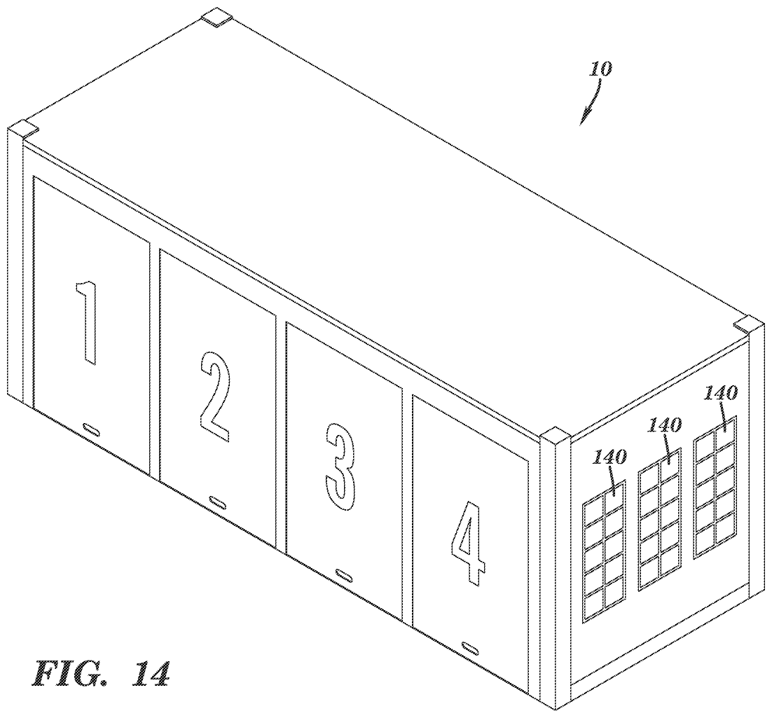

FIG. 14 depicts a perspective view of front and side walls of the charging hub. Charging hub 10 may include a plurality of battery lockers 140, wherein each battery locker 140 is adapted to receive, hold, and charge a swappable battery. Battery lockers 140 are shown attached to one end of charging hub 10 but may be attached to other surfaces of the charging hub 10. Swappable battery may be rechargeable and may be used to power micro-mobility rechargeable vehicles 8. Battery lockers 140 may be connected to power source 18. Access to charging hub 10, bays 12, and battery lockers 140 may be controlled by a lock including any know manner of key, code, or other access control mechanism. The door locks are designed with the flexibility to allow one person to access all or multiple people to access multiple doors, but only one unique method to access a door is allocated at a time. This is done through a reservation system and method wherein access is transmitted to a user making a reservation.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A charging hub for charging micro-mobility vehicles (e-vehicles), comprising:
a rectangular box-like shipping container with at least one door;
a power source leading to the container;
one or more rectangular box-like bays inside the shipping container, wherein each bay has at least one door and a floor;
a plurality of smart charging stations configured to charge e-vehicles inside each bay and connected to the power source; and
a vertically tiered charging platform inside each bay, wherein each tier includes at least one of the smart charging stations.

2. The charging hub of claim 1, wherein each smart charging station includes at least one notch in each deck and at least one charging cable.

3. The charging hub of claim 1, wherein the vertically tiered charging platform includes a front deck, a middle deck, and a back deck.

4. The charging hub of claim 3, wherein the front deck is closest to the floor, the middle deck is above the front deck, and the back deck is above the middle deck.

5. The charging hub of claim 4, wherein a middle deck leading edge is set back from the first deck leading edge, and wherein a back deck leading edge is set back from the middle deck leading edge.

6. The charging hub of claim 5, wherein each of the front deck, the middle deck, and the back deck are spaced to accommodate a rear portion of an e-vehicle at each of the smart charging stations.

7. The charging hub of claim 1, further comprising: an outdoor mounted electrical panel.

8. The charging hub of claim 1, further comprising: a fireman safety disconnect panel.

9. The charging hub of claim 1, wherein each bay includes a fire detector and a smoke detector.

10. The charging hub of claim 1, wherein each bay includes a fire suppression system.

11. The charging hub of claim 1, further comprising: at least one exhaust system.

12. The charging hub of claim 1, further comprising: at least one environmental control system.

13. A vertically tiered charging platform, comprising:
a plurality of decks above a surface,
wherein a front deck rests on the surface, and
wherein a middle deck rests on the front deck, and
wherein a middle deck leading edge of the middle deck is set back from the first deck leading edge;
wherein a back deck rests on the middle deck, and
wherein a back deck leading edge is set back from the middle deck leading edge;
at least one notch in each deck; and
at least one charging cable.

14. The vertically tiered charging platform of claim 13, wherein the notch is configured to accommodate a neck of a micro-mobility vehicle.

15. The vertically tiered charging platform of claim 13, wherein a space between the surface and the deck is configured to accommodate a body of a micro-mobility vehicle.

16. The vertically tiered charging platform of claim 13, wherein the charging cable includes a universal plug configured to charge a lithium ion battery of a micro-mobility vehicle.

17. The vertically tiered charging platform of claim 13, wherein the deck includes metal, wood, plastic, or composite material.

18. The vertically tiered charging platform of claim 13, wherein each notch is configured with one of the at least one charging cable

19. A vertically tiered charging platform, comprising:
a plurality of decks above a surface,
wherein the deck rests on the surface, and
at least one smart charging station.

20. The vertically tiered charging platform of claim 19, wherein each smart charging station includes at least one notch in each deck and at least one charging cable.
